(19) United States
(12) Patent Application Publication
(10) Pub. No.: US 2006/0137795 A1
(43) Pub. Date: Jun. 29, 2006

(54) Tread for solid rubber tire

(76) Inventor: Giles A. Hill III, Idabel, OK (US)

Correspondence Address: OSHA LIANG L.L.P., 1221 MCKINNEY STREET, SUITE 2800, HOUSTON, TX, 77010, US

(21) Appl. No.: 11/318,795

(22) Filed: Dec. 27, 2005

Related U.S. Application Data
(60) Provisional application No. 60/639,378, filed on Dec. 27, 2004.

(51) Int. Cl. B60C 11/03

(52) U.S. Cl. 152/209.23; 152/302; 152/323

(57) ABSTRACT

A solid rubber tire and tread for use on a metal wheel rim includes a circumferential solid rubber tire having width and an inner radius at which the solid rubber tire engages across an outer surface of the metal wheel rim. The tire has an exterior rolling surface for rolling contact with the ground and opposed side walls connecting between the inner radius and the outer surface on both sides of the tire. A tire tread is formed with a first plurality and a second plurality of tread channels. The first plurality of tread channels are formed into the tire uniformly spaced circumferentially around the tire and extending inward from one of the sidewalls less than the entire distance across the width. The tread channels extend in a radial outward direction from a minimum tread radius adjacent to the inner radius of the tire and to the exterior surface so that the tread channels continuously extend to the rolling surface as the solid rubber tire wears. The second plurality of tread channels are formed into the tire uniformly spaced circumferentially around the tire and extending inward from the other sidewall less than the entire distance across the width. Each of the tread channels extending in a radial outward direction from a minimum tread radius adjacent to the inner radius of the tire and extending to the exterior surface so that the tread channels continuously extend to the rolling surface as the solid rubber tire wears.

### CROSS-REFERENCE TO RELATED APPLICATIONS

This is a non-provisional utility patent application filed claiming priority to U.S. provisional application Ser. No. 60/639,378 filed Dec. 27, 2004 and incorporated by reference herein in its entirety for all legitimate purposes.

### BACKGROUND OF INVENTION

1. Field of the Invention

The invention relates generally to a solid rubber tire for a vehicle such as heavy construction equipment.

2. Background Art

Solid rubber tires have been used in the place of pneumatic tires for vehicles such as heavy construction equipment to reduce down time due to flat tires. There has been a long and unfulfilled need for concurrently improving the traction, durability, and smoothness of ride provided by solid rubber tires.

### SUMMARY OF INVENTION

A solid rubber tire and tread for use on a metal wheel rim includes a circumferential solid rubber tire having width and an inner radius at which the solid rubber tire engages across an outer surface of the metal wheel rim. The tire has an exterior rolling surface for rolling contact with the ground and opposed side walls connecting between the inner radius and the outer surface on both sides of the tire. A tire tread is formed with a first plurality and a second plurality of tread channels. The first plurality of tread channels are formed into the tire uniformly spaced circumferentially around the tire and extending inward from one of the sidewalls less than the entire distance across the width. Each of the tread channels extending in a radial outward direction from a minimum tread radius adjacent to the inner radius of the tire and extending to the exterior surface so that the tread channels continuously extend to the rolling surface as the solid rubber tire wears. The second plurality of tread channels are formed into the tire uniformly spaced circumferentially around the tire and extending inward from the other sidewall less than the entire distance across the width. Each of the tread channels extending in a radial outward direction from a minimum tread radius adjacent to the inner radius of the tire and extending to the exterior surface so that the tread channels continuously extend to the rolling surface as the solid rubber tire wears. The tread channels have a uniform width and the total of the widths of the tread channels around a circumference at the surface of the tire is less than about 3% percent of the total tire circumference.

Other aspects and advantages of the invention will be apparent from the following description and the appended claims.

### BRIEF DESCRIPTION OF DRAWINGS

FIG. 1 is a side elevation view of a wheel having a solid rubber tire formed thereon with deep tread channels according to one embodiment of the invention.

FIG. 2 is a front view of the solid rubber tire and tread channels of FIG. 1

FIG. 3 is a perspective assembly view of two halves of a metal mold and raw rubber wrapped on a wheel for insertion into the mold for curing in the shape of a tires, and having pin projections for forming side holes and blades for forming deep tread channels in the solid rubber tire according to one embodiment of the present invention.

FIG. 4 is a partial side elevation view of one a solid rubber tire with deep tread channels rolling on the ground under a load according to an embodiment of the invention.

FIG. 5 is a schematic bottom view of the tire of FIG. 4 rolling on the ground looking up at a theoretical “foot print” of the tire tread as it rolls under a load.

### DETAILED DESCRIPTION

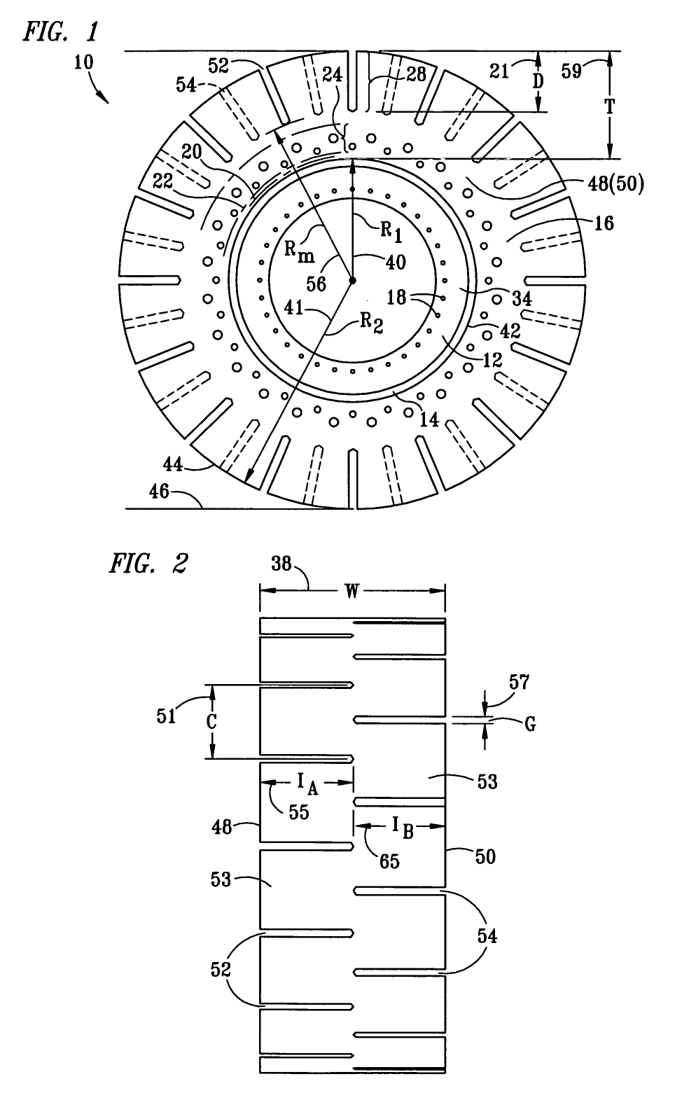

FIGS. 1 and 2 show a wheel and tire assembly 10 according to one embodiment of the invention including a metal hub 12 having a cylindrical rim 14 attached around the periphery of the hub 12 and a solid rubber tire 16 formed around the cylindrical rim 14. The hub 12 has a pattern of mounting holes 18 formed therein for mounting to an axle of a vehicle. The cylindrical rim 14 may have a width generally corresponding to the desired width W of the solid rubber tire 16. A bonding layer of rubber 20 is secured to the cylindrical rim 14 and may also have a width generally corresponding to the width W of the solid rubber tire 16. The bonding layer 20 may be formed of one or of a plurality of sub-layers 22 of raw rubber. By way of example, the raw rubber used to form the bonding layer 20 may be selected so that when the bonding layer 20 of rubber is vulcanized to cure it, the bonding layer 20 will have a hardness of between about 70 and 90 Durometer on the Shore A scale. (All Durometer hardness references in this application are given based upon the Shore A scale.) For example, a bonding layer having a hardness of about 80 Durometer has been found by the inventor to be useful. The bonding layer 20 functions to provide a strong connection between the metal rim 14 and the solid rubber tire 16 formed thereon.

The solid rubber tire 16 is formed and secured on the metal wheel rim 14 at an inner radius R₁ at 40 with tread channels 52 and 54 extending from an exterior radius R₂ at 41 radial inward to a middle radius Rₘ at 56. The difference between R₂ and Rₘ defines the depth D at the tread channels 54. The solid rubber tire 16 is formed of circumferential solid rubber tire layers 20, 22 including a bonding layer 20, a soft layer 24 and a wear layer 28, each layer having a width W at 38. The solid rubber tire 16 engages across an outer surface 42 of a metal wheel rim 14. As with the bonding layer 20, the soft layer 24 may be formed of a plurality of sub-layers 26 and the wear layer 28 may be formed of a plurality of wear sub-layers 30. The total of the layers (and/or sub-layers) are cured to form the tire 16 with an exterior rolling surface 44 for rolling contact with the ground 46. Opposed side walls 48 and 50 result and extend between the inner radius R₁ at 40 and the outer surface 44. A first plurality of tread channels 52 are formed in the solid rubber tire 30 uniformly spaced apart a distance C at 51 circumferentially around the tire 30 and extending inward from one of the opposed sidewalls 48. In this embodiment, the channels 52 each extends inward from side wall 48 a distance I_{A} at 55 that is less the entire width W at 38 of the tire 30. It has been found that an inward distance I_{A} at 55 of about one-half the distance across the width W at 38 is useful in one embodiment of the invention. A second plurality of tread channels 54 (shown with hidden lines in FIG. 1) are formed uniformly spaced circumferentially around the tire 16 extending inward from the other opposed sidewall 50 a distance I_{B} at 65 that is less the entire width W at 38 of the tire 30, for example about half the distance across the width W at 38. The tread channels 54 are offset circumferentially from the channels 52 so the each channel 54 is interposed between the channels 52. Each tread channel 52 and 54 extends to the surface 44 in a radial outward direction from a minimum tread radius Rₘ at 56 to a tread radius R₂ at 41. The minimum tread radius Rₘ at 56 is about the same and slightly larger than the inner radius R₁ at 40.

The depth 21 of the channels 52 and 56 has been found to be usefully provided so that the tread channels extend substantially entirely through the wear layer 28 of the tire 16. Thus, the tread channels 52 and 54 generally indicate the smallest diameter to which the tire should be allowed to wear. Solid rubber tires have been found by the inventor to be usefully constructed to have a wear layer thickness at 28 between about 45% and 75% of the total thickness of the tire. The thickness of the bonding layer 20 and the soft layer 24 combined may be about 25% to 55% of the total thickness of the rubber tire. For example, in a 72 inch diameter tire (R₂ about 36 inches), where the rim is about 38 inches in diameter (R₁ about 19 inches), the total radial thickness T at 59 of rubber of the tire 30 may be about 17 inches. The wear layer 28 may have a thickness of about 10 inches and the tread channels may have a depth D at 21 of about 9 inches deep and therefore, the tread channels 52 and 54 extend almost entirely through the wear layer 28. Thus, the channels 52 and 54 extend from the minimum radius Rₘ at 56 to the exterior surface 44 so that the tread channels continuously extend to the rolling surface as the solid rubber tire is used and progressively wears through the wear layer. At the surface 44 the circumferential space between each of the channels 52 would be about 14.5 inches in the example. Also the gap G at 57 might be about 1.5 inches in this example.

Each channel 54 extends in a radial outward direction from a minimum tread radius Rₘ to the exterior surface 44 at tread radius R₂. Thus, the plurality of tread channels 52 and 54 continuously extend to the rolling surface 44 as the solid rubber tire 16 wears down to a minimum radius Rₘ.

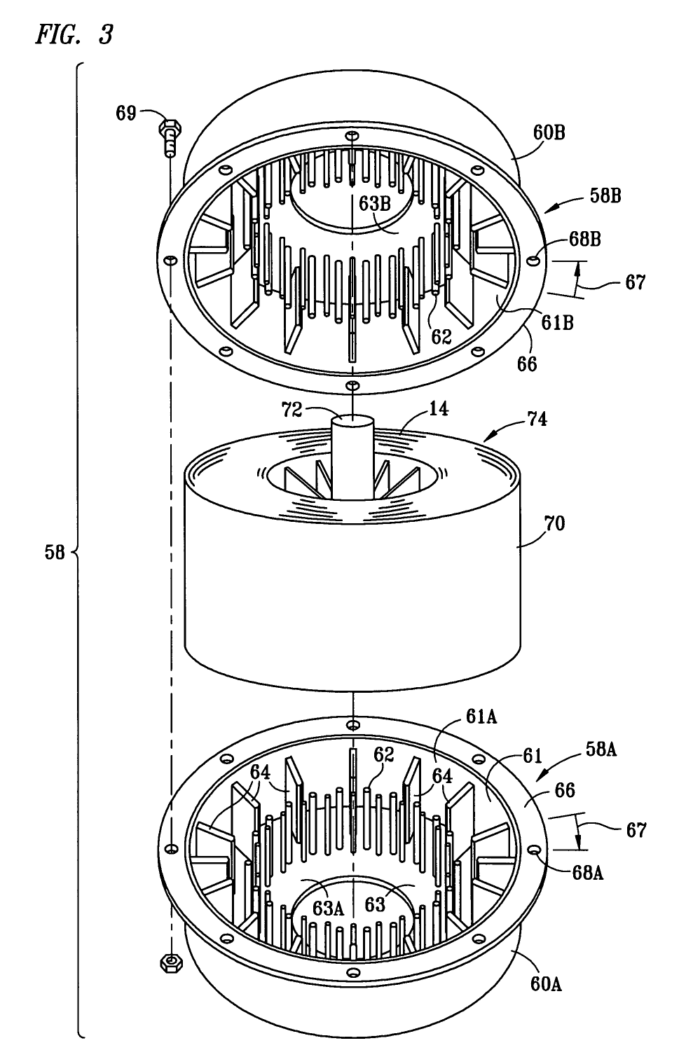

FIG. 3 shows two halves 58A and 58B of a mold 58 used to form the tire and rim assembly 10 with the tread channels 52 and 54. The mold 58 may be comprised of the two substantially symmetrical halves 58A and 58B. Each of the halves 58A and 58B may be substantially the same size and configuration as the other half 58B and 58A, respectively, and may be the mirror image of such other halves. A circumferential case 60 formed with case parts 60A and 60B may be formed with interior circumferential walls 61A and 61B and side walls 63A and 63B, respectively. A plurality of projection pins 62 are affixed to and project axially inward from the side walls 63A and 63B. A plurality of plates 64 for forming tread channels are secured to the side walls 63A and 63B and to the inner circumferential walls 61A and 61B, respectively. The plates 64 are usefully positioned uniformly spaced around the mold halves 58A and 58B. A mold mounting rim 66 may be provided with a plurality of mounting holes 68 and a plurality of securing fasteners 69 by which the halves of the mold 58A and 58B are ultimately held together during curing of the solid rubber tire. To provide an offset between the projection pins 62 and the tread channel forming plates 64, the halves 58A and 58B having the mounting holes 68A and 68B are positioned offset by one-half a step at 67, or one-half the distance between any two adjacent plates 64, so that the projections 62 and plates 64 are formed offset and interposed with each other. For example, in an embodiment with sixteen equally space tread channels 52 on one side and sixteen equally spaced channels 54 on the other side of the tire 16, an angular amount of offset 67 of about 5.66 degrees will space all thirty-two tread channels 52 and 54 equally around the tire 16 with sixteen tread channels 52 positioned circumferentially midway between sixteen tread channels 54. Those skilled in the are will understand from applicant's disclosure that the specific construction of a mold and the specific number and arrangement of projections and plates is an example of one embodiment and that other constructions, numbers and configurations of the mold, the projections and the plates may be used to form tires having a deep tread construction according to the invention as claimed.

During manufacture according to one embodiment, raw rubber tire 70 is placed on a wheel rim 14 that is held on a mandrel 72 for insertion into the mold 58. The raw rubber tire 70 may be formed by wrapping layers and/or sub-layers of raw rubber 74 with the desired hardnesses and so that multiply wrapped layers build up to the desired thickness in the bonding layer 20, in the soft layer 24, in the wear layer 24 and in the total thickness T at 59 of the tire 16. The raw rubber 70 for the tire is then placed between the mold halves 58A and 58B. The mold halves are then pressed together with the raw rubber tire therebetween and attached to one another using mounting holes 68A and 68B and fasteners 69. An example of one possible type of fastener is shown as a bolt and nut. Other types and arrangements of fasteners could also be used. Vulcanization and bonding is accomplished throughout the entire rubber tire by curing the rubber by heating the entire mold, raw rubber tire, and wheel rim in a pressurize chamber. The cured tire and rim is removed from the mold 58A and 58B and cooled.

Those skilled in the art will understand that a method of manufacturing solid rubber tires disclosed in the prior filed U.S. patent application Ser. No. 10/636,354, titled Solid Rubber Tire, filed Aug. 8, 2003, co-owned by the present inventor and incorporated by reference in its entirety, may be used with aspects of the present teachings to produce a tire and tread according to certain aspect of the invention. For, example, a bonding layer of rubber 20 may be formed having a thickness in a range of from a fraction of an inch to a few inches thick. In one specific example, a bonding layer may be formed about 1 in. thick. The bonding layer may have a hardness of between about 70 and 90 Durometer on the Shore R scale. For example, a hardness of 80 Durometer is found to be useful. A plurality of projection pins 62 may be supported in the mold to provide holes into the rubber tire for additional cushioning of the ride provided by the rolling tire. The portion of the tire through which projection pins 60 are forced may be in the soft layer 24 of raw rubber which may be between about 2 inches to about 6 inches radially. For example, a radial thickness of about 4 in. has been found to be useful. The soft layer may have a hardness of about 30 to 50 Durometer on the Shore R scale. For example, a hardness of about 40 Durometer has been found to be useful. A wear layer is bonded to the soft layer and the blades 64 of the mold are forced into this layer to form the tread channels 52 and 54. The wear layer may be between about 8 inches and 16 inches thick. For example, a wear layer of about 12 inches thick has been found to be useful. The wear layer may have a hardness of between about 55 Durometer and 75 Durometer on the Shore R scale. For example, a wear layer with a hardness of about 65 Durometer has been found to be useful. In one example, two symmetrical mold halves 58A and 58B are offset 5.66 degrees from one another allowing thirty-two of the blades 64 to be uniformly spaced between one another as shown in FIG. 3. It will be understood that the total number and spacing of the blades can be varied without departing from various other aspects or embodiments of the claimed inventive construction

The blades 64 are usefully forced entirely through the wear layer. Thus, forming tread channels 52 and 54 that will be present throughout the entire use of the tire. This will allow the tire 10 to provide substantially the same level of traction at any level of wear. The tread channels 52 and 54 are formed relatively narrow compared to the tire circumference and compared to the lugs 53. For example, the width of the gap formed by of each one of the tread channels 52 and 54 may be in a range of about 0.5% to 1% of the total circumference. For example on a 72 inch diameter tire each tread channel or gap may be about 1 to 2 inches wide, and the lugs may be about 12 to 16 inches wide in the circumferential direction at the exterior surface 44. In one useful embodiment there are sixteen tread channels each 1.5 inches wide on a 72 inch diameter tire such that each of the tread channels account for about 0.7% of the circumferential distance.

In one embodiment, the tread channels may have uniform widths of about 2 inches for a 72 inch diameter tire so that each is less than about 1% of the total circumference and the total of the widths of sixteen tread channels, either the total of the channels 52 or the total of the channels 54, around a circumference at the surface of the tire is less than about 15% percent of the total tire circumference.

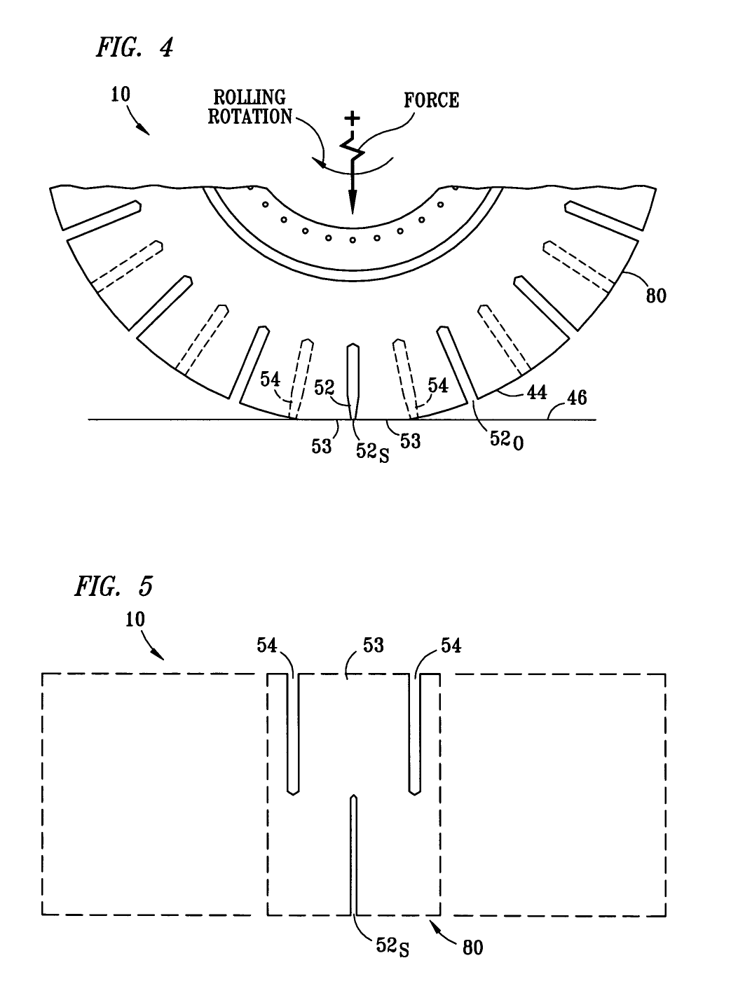

With reference to FIGS. 4 and 5 it will be understood that during use, the narrowness of tread channel 52 and 54 helps to keep larger objects from being caught between the lugs 53 and this unique construction thereby helps to avoid possible tire damage caused by such large objects becoming lodged in the tread channels 52 or 54. It has been found by the inventor that large objects engaged in large tread gaps can have sufficient traction against the ground, because of the large size of the object, to cause damage or “chunking” of the rubber lugs 53. Furthermore, due to the depth of the tread channels 52 and 54, the lugs 53 are allowed greater flexibility. This provides an improved quality of ride, because the rubber is not ‘trapped’ in all directions and instead has the ability to flex into the gap G at 57.

As will be further understood with reference to FIGS. 4 and 5, not only is the ride improved by treaded flexure of the deep channel 52 or 54, but the flexure at the rolling contact surface 46, combined with the narrowness of the tread channels, causes the exposed tread channel to compress toward itself thereby further closing the gap to reduce the size of objects that might become lodged. For example, in FIGS. 4 and 5, one can compare the anticipated action of the compressed channel 52s at the rolling contact surface to tread channel 52o at a position out of contact with the surface 46.

Improved traction is also provided due to the tire being able to follow the terrain more closely. The flex provided by the tread channel depth, either alone (i.e., without the side wall perforations as shown in FIG. 4), or in combination with the open and compressible side wall perforations created by the projection pins 62 during molding as shown in FIG. 1. The compressed spacing between the tread channels 52 and 54 during load bearing rolling of the tire tread will create a footprint 80 of the tire 10 that is greater in the rolling direction than the distance between tread channels 52 and 54. This results in providing a solid rubber tire tread having at least one tread channel in contact with the rolling surface 46, thereby allowing water at the surface 44 adjacent to the channel 52 to or 54 to be squeegeed sideways out from under the tire 10 at any degree of rotation. This helps to provide good traction on wet and loose surfaces.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A solid rubber tire and tread for use on a metal wheel rim, the solid rubber tire and tread comprising:
a circumferential solid rubber tire having a tire width, having an inner radius at which the solid rubber tire engages across an outer surface of a metal wheel rim, having an exterior rolling surface for rolling contact with the ground, and having opposed side walls connecting between the inner radius and the outer surface;
a tread comprising a first and a second plurality of tread channels, the first plurality of tread channels uniformly spaced circumferentially around tire extending inward from one of the sidewalls a distance that is less than the entire width of the tire, the second plurality of tread channels uniformly spaced circumferentially around the tire and offset from the first plurality of tread channels and extending inward from the other sidewall a distance that is less than the entire width of the tire and each tread channel extending in a radial outward direction from a minimum wear tread radius adjacent to the inner radius and extending to the exterior surface so that the first and second plurality of tread channels continuously extends to the rolling surface as the solid rubber tire wears to the minimum wear tread radius.

2. The solid rubber tire and tread of claim 1, wherein the first and second plurality of tread channels each have a width less that about 1% of the total circumference of the tire.

3. The solid rubber tire and tread of claim 1, wherein the first and second plurality of tread channels each have a width that is that is about 0.7% of the total circumference of the tire.

4. The solid rubber tire and tread of claim 1, wherein the first and second pluralities of tread channels are offset from each other so that each one of the first plurality of tread channels is offset a substantially equal circumferential distance from each one of the second plurality of channels.

5. The solid rubber tire and tread of claim 1, wherein the tire further comprises;
a bonding layer secured to the metal wheel rim;
a soft layer secured to the bonding layer, and
a wear layer secured to the soft layer.

6. The solid rubber tire and tread of claim 5, wherein the bonding layer is thinner than the soft layer, the soft layer is thinner than the wear layer, and the tread channels are formed entirely in the wear layer of the tire.

7. The solid rubber tire and tread of claim 5, wherein the bonding layer and the soft layer together have a thickness in a range of about 25% to 55% of the total tire thickness and the wear layer has a thickness in a range of about 45% to 75% of the total thickness of the tire.

8. The solid rubber tire and tread of claim 5, wherein perforations are formed in the soft layer in a pattern radially positioned from the rim and each tread channel extends in a radial outward direction from a radius larger that is radially outward from the pattern of perforations.

9. The solid rubber tire and tread of claim 1, wherein each tread channel extends axially inward from one of the sidewalls about one-half the width of the tire.
